(19) United States
(12) Patent Application Publication
(10) Pub. No.: US 2026/0200156 A1
(43) Pub. Date: Jul. 16, 2026

(54) TEMPERATURE-RESISTANT PLA STRAW AND PREPARATION METHOD THEREFOR

(71) Applicant: Taizhou Corn Environmental Protection Technology Co., Ltd., Taizhou (CN)

(72) Inventors: Wenguang LI, Midlothian, VA (US); Yonglei LIU, Linyi (CN); Qizao CHEN, Taizhou (CN); Yang TAO, Taizhou (CN); Qian HU, Taizhou (CN); Yujie JIN, Taizhou (CN); Guochao HUANG, Taizhou (CN); Yuting ZHU, Taizhou (CN)

(73) Assignee: Taizhou Corn Environmental Protection Technology Co., Ltd., Taizhou (CN)

(21) Appl. No.: 18/988,898

(22) Filed: Dec. 20, 2024

Related U.S. Application Data
(63) Continuation of application No. PCT/CN2023/084793, filed on Mar. 29, 2023.

(30) Foreign Application Priority Data
Jun. 20, 2022 (CN) 202210698661.0

(51) Int. Cl. B29C 48/09; B29C 71/00; B29K 67/00; C08J 9/00; C08J 9/12

(52) U.S. Cl. CPC B29C 48/09; B29C 71/009; C08J 9/0061; C08J 9/122; B29K 2067/046; C08J 2203/06; C08J 2203/08; C08J 2367/04

(57) ABSTRACT

The present application belongs to the technical field of tableware, and relates to a preparation method for a thermo-resistant PLA straw. The method includes the following steps: subjecting a PLA straw raw material to a tube drawing process via an extruder to prepare a straw preform, the straw preform includes PLA that is not fully crystallized; and subjecting the straw preform to a constant-temperature and constant-pressure carbon dioxide soaking treatment, such that the uncrystallized PLA in the straw sample blank is crystallized, obtaining a PLA straw product with a temperature resistance of higher than or equal to 70° C. The present application further provides a thermo-resistant PLA straw. The straw is a microfoamed product; the density of the straw is reduced by 5-30% relative to the density of the straw preform; and the straw has a temperature resistance of 70° C. or above.

### CROSS-REFERENCE TO RELATED APPLICATIONS

The present disclosure is a continuation application of International Application No. PCT/CN2023/084793, filed on Mar. 29, 2023, which claims priority to Chinese Patent Application No. 202210698661.0, filed on Jun. 20, 2022. The disclosures of the above-mentioned applications are hereby incorporated by reference in their entireties.

### TECHNICAL FIELD

The present disclosure belongs to the technical field of tableware, and relates to a thermo-resistant PLA straw and a preparation method therefor.

### BACKGROUND

Straw is a daily necessity in the tableware industry. In China alone, as many as 1.5 billion straws are consumed every day, and with the rise and rapid development of new lifestyles such as snacks, takeaway, milk tea industry, straw consumption is rising. As straws belong to disposable consumer goods, large amounts of raw material resources are consumed every day, and the wastes therefrom are also polluting the environment, which has become one of the most urgent plastic articles to be dealt with in the country.

At present, there are several straws in the market:

(1) PP straw. It is thermo-resistant, non-degradable and inexpensive, but pollutes the environment, China has issued the Plastic Ban to ban production and sales of this kind of straw completely.

(2) Paper straw. It is thermo-resistant as well as degradable, but when exposed to liquids, it tends to soften and even cannot be used for sucking, leading to a poor user experience, especially in the milk tea industry, which is not popular in the market.

(3) PLA straw. Since the degraded plastic PLA has comparable properties to conventional plastic PP, PLA is chosen to make degraded plastic straws. However, the processability of PLA straws is not good, and other degradable plastics such as PBAT or PBS must be added as processing aids to make PLA straws. However, due to the slow crystallization rate of PLA, it is generally difficult to completely crystallize during a tube drawing production process, PLA straws are generally thermo-resistant and easily bend and deform when exposed to heat, and are generally only used as cold drink straws.

At present, by controlling the content of PBS component, PLA straws with a temperature resistance of 70° C. can be made. However, the quality of this product is unstable, mainly due to large fluctuation in the quality of PBS raw materials, and there is often the phenomenon that the physical and chemical detection of small molecule dissolved substances is not up to the standard. Therefore, the temperature resistance and product quality stability of such PLA straws have been urgent problems to be solved.

PLA straw product with a temperature resistance of 70° C. can also be prepared by selecting a special brand of PLA raw material, heat treatment after tube drawing, and recrystallizing PLA. However, since the heat treatment (drying tunnel, hot blowing, infrared heating, etc.) is not easy to be uniform, the straw is deformed and the product quality is reduced.

At present, the supply and demand market of biodegradable plastics is not balanced, the price of raw materials is high, and the price of PLA straw is high. How to lower the price of products has been the requirement and challenge for the development of PLA straw market, and also the condition for the survival and development of manufacturers. Therefore, following the changes in the market, new products with high quality and low price are continuously launched to meet the needs of customers, which is the development trend of biodegradable plastics market and the key to replace the traditional plastic products with degradable plastics.

However, no matter what formula is used for PLA straw, PLA cannot be completely crystallized as long as the straw is produced by an extruder with the tube drawing process. Because PLA itself is a slowly crystallized polymer, its glass transition temperature (50° C.-60° C.) is at room temperature or above; further, because the process is extremely rapid as an extruder die is pulled from PLA melt until the pipe is cooled to solidify in water, PLA straw readily forms articles in an amorphous or partially crystalline state. When the product is again subjected to elevated temperatures, PLA may recrystallize above the glass transition temperature (commonly referred to as cold crystallization), resulting in a change in the shape of the product. This is why PLA straws are not thermo-resistant.

In order to solve the problem of the temperature resistance of PLA straws, PBS capable of rapid crystallization is added to the formula of PLA straws, so that PLA straw products with a temperature resistance of 70° C. could be prepared. However, since the PBS product contains small-molecule monomer leachable which is not easy to be removed, there is a risk of substandard physical and chemical test on PLA straw. Furthermore, more PBSs are added in this way, and in fact the temperature resistance of PLA straw depends on the crystallization of PBS to support the stable skeletal structure of the product thereof. At present, PBS has limited capacity and high price, and this thermo-resistant PLA straw has high price and cannot be easily made low, resulting in limited market development of PLA straw.

In comparison with the above-mentioned thermo-resistant PLA straw of PBS, the crystalline PLA straw product that has recently appeared is prepared from a high-melting point and readily-crystallizable PLA raw material, and the content of PBS is reduced in the formula; or PLA, PBAT, and a nuclear agent raw material are added, and after the straw is formed by melt extrusion and tube drawing, a heat treatment process is performed to recrystallize PLA, and the final straw product can resist a temperature of 70° C.-80° C. However, this crystallized PLA straw uses a special brand of PLA, and the market scale of this straw product is limited due to the insufficient capacity of PLA; in addition, the heat treatment process is not easy to achieve precise control, the product is easy to deform, the quality fluctuation is large, and the straw waste and defective rate are high.

There are very few documents about thermo-resistant PLA straws, and the following patent documents have been found: Chinese Patent Publication CN12521735A discloses a thermo-resistant PLA straw and a preparation method therefor, wherein the straw is prepared by a three-layer co-extrusion technique, wherein an inner layer and an outer layer includes a copolymer polylactic acid component of a benzene ring, and the middle layer is an aliphatic polyester (PBS or PBAT). The temperature resistance of PLA straw is mainly achieved by self-made copolymer polylactic acid, and it is difficult to achieve mass production. In addition, three-layer co-extrusion technology is still an application attempt of new technology. Chinese Patent Publication CN13004669A discloses a method for preparing a thermo-resistant straw, wherein nano-sized cross-linking nucleation points are used to improve the crystallinity of PLA by adding a trace amount of a cross-linking agent so as to achieve a temperature resistance of 80° C. for PLA straw. The difficulty in this micro-cross-linking nucleation technique is how to uniformly disperse a small amount of cross-linking agent, otherwise the product is difficult to achieve uniformity. Chinese Patent Publication CN113088052 discloses a method for preparing a high temperature resistant modified carbon dioxide-based transparent straw, wherein the composition formula of the straw is 5-10 parts of carbon dioxide-based PPC, 20-35 parts of PLA, 60-70 parts of PBS, 0.2-0.3 parts of a dispersant, 0.1-0.3 parts of a compatibilizer, and 0.1-0.3 parts of a lubricant. The high temperature resistant transparent straw can be obtained by annealing at 100° C.-110° C. after the straw is tube drawn. The methods of making the thermo-resistant straws described above are basically accomplished by changing the composition of the straw formula or heat treatment of the general product. Nowadays, biodegradable plastics resources are very limited, the industry has tried various formula combinations, and how to use the existing biodegradable plastic materials to develop a thermo-resistant PLA straw to meet the market needs is undoubtedly a great challenge in the tableware industry.

### SUMMARY

According to the differences in the prior art, the present disclosure provides a thermo-resistant PLA straw and a preparation method therefor, the prepared PLA straw has the advantages of temperature resistance and heat insulation, and is also biodegradable, thereby making PLA straw a new-generation environmentally friendly straw product.

In order to solve the above technical problem, an object of the present disclosure is achieved by the following technical solutions:
a method for preparing a thermo-resistant PLA straw, which includes the following steps:
(1) subjecting a PLA straw raw material to a tube drawing process via an extruder to prepare a straw preform, wherein the straw preform includes PLA that is not fully crystallized; and
(2) subjecting the straw preform to a constant-temperature and constant-pressure carbon dioxide soaking treatment, such that the uncrystallized PLA in the straw preform is crystallized, obtaining a PLA straw product with a temperature resistance of 70° C. or above (referred to as the highest temperature resistance of 70° C. or above).

In the above-mentioned method for preparing the thermo-resistant PLA straw, the raw material for PLA straw in step (1) includes the following components by mass:
30%-80% of a major material;
5%-40% of an auxiliary material;
10%-35% of a filler; and
0-5% of a modifier;
where the major material is PLA;
the auxiliary material is PBAT, PBS or a blend of PBAT and PBS;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent; the amount and type of the filler and the modifier added should not affect an effect of carbon dioxide, performance of the straw and an environmentally friendly concept; the modifier may also be not added as required.

In the above-mentioned method for preparing the thermo-resistant PLA straw, particles prepared by an extrusion blending and pelletizing process are used as the raw material for PLA straw in step (1).

In the above-mentioned method for preparing the thermo-resistant PLA straw, where a method of the carbon dioxide soaking treatment in step (2) includes: placing PLA straw preform in a temperature-adjustable closed container with high temperature and high pressure resistance, injecting the carbon dioxide into the closed container, and soaking at a constant temperature and under retained pressure, quickly releasing the pressure after the soaking, opening the container, taking out the sample, and cooling at room temperature to obtain a product; and the container with high temperature and high pressure resistance is any closed container that can be temperature-adjustable and pressure resistant.

In the above-mentioned method for preparing the thermo-resistant PLA straw, in step (2), a pressure retaining temperature is 40° C.-105° C., a pressure retaining pressure is 4-13 MPa, a pressure retaining time is 1-30 minutes, and a pressure release speed is 5-45 MPa/s;

In the above-mentioned method for preparing the thermo-resistant PLA straw, the carbon dioxide is a supercritical carbon dioxide fluid or a subcritical carbon dioxide fluid.

In the above-mentioned method for preparing the thermo-resistant PLA straw, straw products with different thermo-resistance are obtained by adjusting the formula and soaking parameters respectively, and in general, with the same formula, the higher the pressure retaining temperature, the higher the temperature resistance of the resulting straw product.

The products provided by the present disclosure are respectively as follows:
a thermo-resistant straw product having a temperature resistance of 70° C. or above and below 100° C.; and
a highly thermo-resistant straw product having a temperature resistance above 100° C.

In the above-mentioned method for preparing the thermo-resistant PLA straw, by adjusting soaking parameters, a straw product with a low density is obtained; in general, the greater the pressure retaining pressure, the faster the pressure release speed, and the lower the density of the resulting product.

Alternatively, the pressure retaining pressure is 9 MPa or above, and the pressure release speed is 31 MPa/s or above; preferably, the pressure retaining pressure is 12 MPa or above and the pressure release speed is 41 MPa/s or above; density of the resulting straw product is 5%-30% lower than that of a straw preform.

The present disclosure also provides a thermo-resistant PLA straw which is a microfoamed product; the density of the straw is reduced by 5%-30% relative to the density of the straw preform; and the straw has a temperature resistance of 70° C. or above.

The present disclosure has the following advantageous effects as compared with the prior art.

Firstly, the present disclosure provides a method for preparing a new PLA straw. Under certain conditions of temperature and pressure, the carbon dioxide fluid can rapidly dissolve and penetrate into PLA straw, which can eliminate internal stress caused by an orientation of the extruded melt tubedrawn molecules, assist the movement of PLA macromolecular chains, and adjust spatial structure arrangement of PLA macromolecular chains without causing bending deformation of the straw, PLA can be induced to complete crystallization, and the strength and temperature resistance of PLA straw can be changed; better results are obtained when supercritical fluid carbon dioxide is used as the carbon dioxide fluid.

Secondly, the present disclosure can generate micro-nano cell structure inside PLA straw through rapid pressure release and rapid gasification and expansion of carbon dioxide, so that the density of the product is reduced, and the toughness is increased. The micro-nano cell structure can provide the straw with the function of heat insulation and temperature resistance, without being too hot or cold to the hands.

Thirdly, the process parameters of the present disclosure can be precisely controlled, and the product quality is stable; because the straw is immersed in carbon dioxide fluid, there is no bending deformation which is heated unevenly, the amount of crystallization can also be accurately controlled, and the product quality of thermo-resistant PLA straw is more stable and reliable.

Fourthly, the present disclosure can reduce the cost, since the carbon dioxide soaking treatment of the straw can induce complete crystallization of PLA, less or no nucleating agent and a less expensive material formula are used, and crystallized PLA straw can also be produced. In addition, the straw can also be made into a micro-nano cell structure, thereby reducing the amount of the raw materials and the production cost of the product.

Fifthly, the present disclosure, PLA is used as a major material, and the thus-produced straw product is biodegradable, and the waste after use does not cause environmental pollution.

Sixthly, the present disclosure helps replacement of existing PP or paper straw with PLA straw, which reduces the difference in price between traditional plastic tableware and biodegradable plastic tableware while having a better appearance of being opaque, reflective, rigid and tough, resulting in a better user experience and creating a new environmentally friendly straw product.

At last, the present disclosure also provides a new straw, which is currently in the market in the form of a non-foamed straw, but the straw of the present disclosure is in a micro-foamed form. During an in-depth study on the carbon dioxide fluid treatment on PLA straws, the researchers have surprisingly found that PLA straws, after being microfoamed, have unexpectedly new properties that, in addition to being thermo-resistant, have a temperature resistance and heat insulation effect that makes the straws more comfortable against liquid temperatures during use.

### DETAILED DESCRIPTION OF THE EMBODIMENTS

The present disclosure is further illustrated by the following description of specific embodiments, which are not to be construed as limiting the present disclosure, and various modifications and improvements can be made by a person skilled in the art without departing from the basic idea of the present disclosure.

The method for determining each test data in this example is as follows.

The method for determining density of the straw in this example is as follows.

According to the principle of Archimedes' buoyancy, by using a drainage method, samples of the straw are respectively weighed to obtain a weight in air (W₁) and a weight in water (W₂), wherein the difference between the weights is a buoyancy (F) experienced by the samples, which is equal to a volume of one sample (Vₛ) multiplied by density of water (d_{w}). The density (dₛ) of the sample can then be calculated.

$$F = {W}_{1} - {W}_{2} = {d}_{w} * {V}_{s}$$

$${d}_{s} = {W}_{1} / {V}_{s} = {d}_{w} * {W}_{1} / ( {W}_{1} - {W}_{2} )$$

In the example, the method for calculating the density decrease percentage of the straw is as follows:
density of the straw preform is d₀ and density of the straw product is d_{f}, after carbon dioxide treatment, micro-nano cell structures are generated inside the straw, and the density decrease percentage X thereof is:

$$X ( \% ) = ( {d}_{0} - {d}_{f} ) / {d}_{0} * 100$$

In this example, the method for determining the temperature resistance of the straw is as follows:

200 grams of glass beads are measured and placed into a 500 ml beaker, about ¾ of the beaker of water is poured into the beaker, the beaker is placed into a thermostatic water bath with a set temperature, when the temperature in the beaker reaches the desired temperature, a straw is inserted into the beaker, and the straw is used for stirring for 20 cycles along the bottom of the beaker wall, within 10 seconds; the state of the straw during and after the stirring is observed. If the straw becomes soft during stirring and cannot be stirred smoothly, or deforms seriously after stirring, the test may be ended, and it is determined that the straw cannot resist the temperature. If the straw can still maintain the original state, it is determined that the straw can resist the temperature.

The raw material sources in the examples of the present disclosure are as shown in Table 1-1:

TABLE 1-1
Raw materials and source

| | Brand or | |
|---|---|---|
| Compounds | specification | Source |
| PLA (formulas 1-5, 9-10) | 110 | Zhejiang Hisun |
| | | Biomaterials Co., Ltd. |
| PLA (formulas 6-8) | 810 | BBCA GROUP |
| PBAT | KHB21AP11 | Kanghui New Material |
| | | Technology Co., Ltd. |
| PBS | 803S | Xinjiang Blue Ridge |
| | | Tunhe Sci.&Tech. Co., |
| | | Ltd. |
| Talcum powder | 1250 Meshes | Commercially available |
| Calcium carbonate | 2500 Meshes | Jiangxi Guangyuan |
| | | Chemical Co., Ltd. |
| Chain extender | CE2104 | Innovation New |
| | | Material Technology |
| | | Co., Ltd. |
| Plasticizer | HC1910 | Huace Environmental |
| | | Protection Technology |
| | | Co., Ltd. |

TABLE 1-2
PLA straw raw material formula, straw density and temperature resistance

| | | | | | | | Temperature |
|---|---|---|---|---|---|---|---|
| | | | | | | | resistance |
| | | | | | | | (highest |
| | | | | | | | temperature |
| Formula | PLA | PBAT | PBS | Filler | Modifier | Density | resistance) |
| number | (%) | (%) | (%) | (%) | (%) | (g/cm³) | (° C.) |
| 1 | 65 | 20 | | 15 | | 1.358 | 55 |
| 2 | 45 | 30 | | 25 | | 1.413 | 55 |
| 3 | 70 | 15 | | 15 | | 1.357 | 55 |
| 4 | 50 | 15 | | 35 | | 1.407 | 55 |
| 5 | 30 | | 40 | 30 | | 1.504 | 70 |
| 6 | 80 | | 10 | 10 | | 1.328 | 55 |
| 7 | 60 | | 25 | 15 | | 1.413 | 55 |
| 8 | 70 | | 15 | 15 | | 1.371 | 55 |
| 9 | 60 | 5 | 10 | 25 | | 1.447 | 55 |
| 10 | 65 | 20 | | 15 | 1.5 | 1.343 | 50 |

*A filler of formula No. 10 is calcium carbonate and the fillers of the other formula numbers are talc; the filler of formula No. 10 contains 0.5% chain extender and 1% plasticizer (a total of 1.5% modifier); the fillers of other formula numbers do not contain any modifiers.

The PLA straw samples are prepared as follows in the embodiments.

### (1) Preparation of PLA Straw Preforms:

according to the composition of formulas in Table 1-2, 10 total formulas of PLA straw preforms are prepared with PLA as the major material, PBAT or PBS or a blend of PBAT and PBS as the auxiliary material and talcum powder or calcium carbonate as the filler respectively. The preparation method is as follows: the raw material particles of various formulas are prepared by an extrusion blending and pelletizing process. These raw material particles are used to prepare PLA straws of a predetermined size and weight through a process of screw extrusion of the melt, tube drawing, water cooling shaping, clipping, collecting, etc. These PLA straw preforms are generally not thermo-resistant and can only be used as cold drink straws.

### (2) Preparation of PLA Straw Samples:

PLA straw preforms are soaked in a carbon dioxide closed container (mold) with constant temperature and pressure for a predetermined time, then rapid pressure release to open the mold is performed, the samples are taken out and cooled at room temperature, so as to obtain PLA straw product. The carbon dioxide treatment process conditions for PLA straw with different formulas are as shown in Table 2.

TABLE 2
Carbon dioxide treatment processing conditions and performance test of PLA straw

| | | | | | | | | Temperature |
|---|---|---|---|---|---|---|---|---|
| | | | | | | | | resistance |
| | | Pressure | Pressure | Pressure | Pressure | | | (highest |
| | | retaining | retaining | retaining | release | Product | Density | temperature |
| | | Temperature | pressure | time | speed | density | reduction | resistance) |
| Example # | Formula # | (° C.) | (MPa) | (minute) | (MPa/s) | (g/cm³) | (%) | (° C.) |
| 1 | 1 | 40 | 4.5 | 6 | 16 | 1.350 | 0.5 | 75 |
| | 2 | 40 | 4.5 | 6 | 16 | 1.414 | −0.1 | 75 |
| | 3 | 40 | 4.5 | 6 | 16 | 1.360 | −0.2 | 75 |
| | 4 | 40 | 4.5 | 6 | 16 | 1.407 | 0.0 | 75 |
| | 5 | 40 | 4.5 | 6 | 16 | 1.499 | 0.3 | 90 |
| | 6 | 40 | 4.5 | 6 | 16 | 1.323 | 0.4 | 90 |
| | 7 | 40 | 4.5 | 6 | 16 | 1.410 | 0.2 | 80 |
| | 8 | 40 | 4.5 | 6 | 16 | 1.366 | 0.4 | 75 |
| 2 | 1 | 50 | 4 | 30 | 14 | 1.354 | 0.3 | >100 |
| | 2 | 50 | 4 | 30 | 14 | 1.417 | −0.3 | 95 |
| | 3 | 50 | 4 | 30 | 14 | 1.359 | −0.1 | >100 |
| | 4 | 50 | 4 | 30 | 14 | 1.403 | 0.3 | >100 |
| | 5 | 50 | 4 | 30 | 14 | 1.508 | −0.3 | 95 |
| | 6 | 50 | 4 | 30 | 14 | 1.325 | 0.2 | >100 |
| | 7 | 50 | 4 | 30 | 14 | 1.414 | −0.1 | >100 |
| | 8 | 50 | 4 | 30 | 14 | 1.367 | 0.3 | ≤100 |
| 3 | 1 | 70 | 12 | 20 | 41 | 1.061 | 21.9 | 95 |
| | 3 | 70 | 12 | 20 | 41 | 1.108 | 18.3 | >100 |
| | 4 | 70 | 12 | 20 | 41 | 1.097 | 22.0 | >100 |
| 4 | 1 | 80 | 12 | 6 | 41 | 1.037 | 23.6 | 75 |
| | 3 | 80 | 12 | 6 | 41 | 1.084 | 20.1 | 85 |
| | 4 | 80 | 12 | 6 | 41 | 1.064 | 24.4 | 85 |
| 5 | 1 | 90 | 9 | 20 | 31 | 1.055 | 22.3 | 70 |
| | 1 | 90 | 11 | 6 | 38 | 1.081 | 20.4 | 90 |
| 6 | 4 | 90 | 13 | 6 | 45 | 1.048 | 25.5 | >100 |
| | 6 | 90 | 13 | 6 | 45 | 1.139 | 14.2 | >100 |
| | 7 | 90 | 13 | 6 | 45 | 1.079 | 23.7 | >100 |
| | 8 | 90 | 13 | 6 | 45 | 1.123 | 18.1 | >100 |
| 7 | 3 | 103 | 12 | 1 | 41 | 1.011 | 25.5 | >100 |
| | 4 | 103 | 12 | 1 | 41 | 1.036 | 26.3 | >100 |
| | 6 | 103 | 12 | 1 | 41 | 1.108 | 16.5 | >100 |
| | 7 | 103 | 12 | 1 | 41 | 1.145 | 18.9 | >100 |
| | 8 | 103 | 12 | 1 | 41 | 1.112 | 18.9 | >100 |
| 8 | 1 | 90 | 4 | 6 | 14 | 1.362 | −0.3 | >100 |
| | 3 | 90 | 4 | 6 | 14 | 1.369 | −0.8 | >100 |
| | 4 | 90 | 4 | 6 | 14 | 1.409 | −0.2 | >100 |
| | 6 | 90 | 4 | 6 | 14 | 1.330 | −0.2 | >100 |
| | 7 | 90 | 4 | 6 | 14 | 1.418 | −0.4 | >100 |
| | 8 | 90 | 4 | 6 | 14 | 1.373 | −0.1 | >100 |
| 9 | 9 | 55 | 4.5 | 6 | 16 | 1.444 | 0.2 | 75 |
| 10 | 10 | 105 | 4 | 6 | 14 | 1.347 | −0.3 | 70 |

### Example 1

PLA straw preforms with formula composition Nos. 1-8 are placed in a mold container at 40° C., carbon dioxide is injected into the container at a pressure of 4.5 MPa, the preforms are soaked at constant temperature and pressure for 6 minutes, rapid pressure release at a speed of 16 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are hardly changed, and the appearance and morphology of the samples are not apparently changed, but all straws have a temperature resistance above 70° C., which could vary from 75° C. to 90° C. with different formulas.

### Example 2

PLA straw preforms with formula composition Nos. 1-8 are placed in a mold container at 50° C., carbon dioxide is injected into the container at a pressure of 4 MPa, the preforms are soaked at constant temperature and pressure for 30 minutes, rapid pressure release at a speed of 14 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are hardly changed, and the appearance and morphology of the samples are not apparently changed, but the temperature resistance of the straws increases to 95° C.-100° C., some straws have temperature resistance above 100° C.

### Example 3

PLA straw preforms with formula composition Nos. 1, 3 and 4 are placed in a mold container at 70° C., carbon dioxide is injected into the container at a pressure of 12 MPa, the preforms are soaked at constant temperature and pressure for 20 minutes, rapid pressure release at a speed of 41 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are reduced by 18.3% to 22%, the appearance of the straw changes from translucent to white (microfoamed product), the straw sample with formula No. 1 has a temperature resistance of 95° C. or below, and the straw samples with formula Nos. 3 and 4 have a temperature resistance above 100° C.

### Example 4

PLA straw preforms with formula composition Nos. 1, 3 and 4 are placed in a mold container at 80° C., carbon dioxide is injected into the container at a pressure of 12 MPa, the preforms are soaked at constant temperature and pressure for 6 minutes, rapid pressure release at a speed of 41 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are reduced by 20.1% to 24.4%, the appearance of the straw changes from translucent to white (microfoamed product), the straw sample with formula No. 1 has a temperature resistance of 75° C. or below, and the straw samples with formula Nos. 3 and 4 have a temperature resistance of 85° C. or below.

### Example 5

PLA straw preform with formula composition No. 1 is placed in a mold container at 90° C., carbon dioxide is injected into the container at pressures of 9 MPa and 11 MPa respectively, the preform is soaked at constant temperature and pressure for 20 minutes and 6 minutes respectively, rapid pressure release at speeds of 31 MPa/s and 38 MPa/s respectively is performed, the mold is opened to take out the sample, and the sample is cooled at room temperature to obtain PLA straw product. The sample is tested for density and temperature resistance and the results are as shown in Table 2. After carbon dioxide treatment, the density of the sample is reduced by 22.3% and 20.4% respectively, the appearance of the straw changes from translucent to white (microfoamed product), and the straw sample has a temperature resistance of 70° C. or below and 90° C. or below respectively.

### Example 6

PLA straw preforms with formula composition Nos. 4 and 6-8 are placed in a mold container at 90° C., carbon dioxide is injected into the container at a pressure of 13 MPa, the preforms are soaked at constant temperature and pressure for 6 minutes, rapid pressure release at a speed of 45 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are reduced by 14.2% to 25.5%, the appearance of the straw changes from translucent to white (microfoamed product), and all the samples have a temperature resistance above 100° C.

### Example 7

PLA straw preforms with formula composition Nos. 3, 4 and 6-8 are placed in a mold container at 103° C., carbon dioxide is injected into the container at a pressure of 12 MPa, the preforms are soaked at constant temperature and pressure for 1 minutes, rapid pressure release at a speed of 41 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are reduced by 16.5% to 26.3%, the appearance of the straw changes from translucent to white (microfoamed product), and all the samples have a temperature resistance above 100° C.

### Example 8

PLA straw preforms with formula composition Nos. 1, 3, 4 and 6-8 are placed in a mold container at 90° C., carbon dioxide is injected into the container at a pressure of 4 MPa, the preforms are soaked at constant temperature and pressure for 6 minutes, rapid pressure release at a speed of 14 MPa/s is performed, the mold is opened to take out the samples, and the samples are cooled at room temperature to obtain PLA straw product. The samples are tested for density and temperature resistance and the results are as shown in Table 2. After carbon dioxide treatment, the densities of the samples are hardly changed, the appearance of the straw changes from translucent to slightly whitish, and all the samples have a temperature resistance above 100° C.

### Example 9

PLA straw preform with formula composition No. 9 is placed in a mold container at 55° C., carbon dioxide is injected into the container at a pressure of 4.5 MPa, the preform is soaked at constant temperature and pressure for 6 minutes, rapid pressure release at a speed of 16 MPa/s is performed, the mold is opened to take out the sample, and the sample is cooled at room temperature to obtain PLA straw product. The sample is tested for density and temperature resistance and the results are as shown in Table 2. After carbon dioxide treatment, the density and appearance are hardly changed, and the appearance of the sample is not significantly changed, but the sample has a temperature resistance of 75° C. or below.

### Example 10

PLA straw preform with formula composition No. 10 is placed in a mold container at 105° C., carbon dioxide is injected into the container at a pressure of 4 MPa, the preform is soaked at constant temperature and pressure for 6 minutes, rapid pressure release at a speed of 14 MPa/s is performed, the mold is opened to take out the sample, and the sample is cooled at room temperature to obtain PLA straw product. The sample is tested for density and temperature resistance and the results are as shown in Table 2. After carbon dioxide treatment, the density and appearance are hardly changed, and the appearance of the sample is not significantly changed, but the sample has a temperature resistance of 70° C. or below.

1. A method for preparing a thermo-resistant PLA straw, wherein the method comprises the following steps:
(1) subjecting a PLA straw raw material to a tube drawing process via an extruder to prepare a straw preform, wherein the straw preform comprises PLA that is not fully crystallized; and
(2) subjecting the straw preform to a constant-temperature and constant-pressure carbon dioxide soaking treatment, such that the uncrystallized PLA in the straw preform is crystallized, obtaining a PLA straw product with a temperature resistance of 70° C. or above;
wherein, a method of the carbon dioxide soaking treatment in step (2) comprises: placing PLA straw preform in a temperature-adjustable closed container with high temperature and high pressure resistance, injecting the carbon dioxide into the closed container, and soaking at a constant temperature and under retained pressure;
in step (2), a pressure retaining temperature is 40° C.-105° C., a pressure retaining pressure is 4-13 MPa, a pressure retaining time is 1-30 minutes, and a pressure release speed is 5-45 MPa/s; and
the carbon dioxide is a supercritical carbon dioxide fluid or a subcritical carbon dioxide fluid.

2. The method for preparing the thermo-resistant PLA straw according to claim 1, wherein straw products with different thermo-resistance are obtained by adjusting the formula and soaking parameters, and the straw products are respectively:
a thermo-resistant straw product having a temperature resistance of 70° C. or above and below 100° C.; and
a highly thermo-resistant straw product having a temperature resistance above 100° C.

3. The method for preparing the thermo-resistant PLA straw according to claim 1, wherein a straw product with a low density is obtained by adjusting soaking parameters; the pressure retaining pressure is 9 MPa or above, and the pressure release speed is 31 MPa/s or above; density of the resulting straw product is 5%-30% lower than that of the straw preform.

4. The method for preparing the thermo-resistant PLA straw according to claim 3, wherein the pressure retaining pressure is 12 MPa or above and the pressure release speed is 41 MPa/s or above.

5. The method for preparing the thermo-resistant PLA straw according to claim 1, wherein PLA straw raw material in step (1) comprises the following components by mass:
30%-80% of a major material;
5%-40% of an auxiliary material;
10%-35% of a filler; and
0-5% of a modifier;
wherein the major material is PLA;
the auxiliary material is PBAT, PBS or a blend of PBAT and PBS;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent.

6. The method for preparing the thermo-resistant PLA straw according to claim 5, wherein particles prepared by an extrusion blending and pelletizing process are used as the raw material for PLA straw.

7. A thermo-resistant PLA straw, wherein the straw is prepared by the preparation method according to claim 3, the straw is a microfoamed product, the density of the straw is reduced by 5%-30% relative to the density of the straw preform, and the straw has a temperature resistance of 70° C. or above.
